(19) United States
(12) Patent Application Publication
(10) Pub. No.: US 2020/0184738 A1
(43) Pub. Date: Jun. 11, 2020

(54) Rideshare Safety System

(71) Applicant: Darrin Ngo, San Francisco, CA (US)

(72) Inventor: Darrin Ngo, San Francisco, CA (US)

(73) Assignee: Beeline Technologies Incorporated, San Francisco, CA (US)

(21) Appl. No.: 16/210,498

(22) Filed: Dec. 5, 2018

(51) Int. Cl. G07C 5/00; G06Q 50/30; G01C 21/34; G07C 5/08; H04W 4/90; H04W 4/40

(52) U.S. Cl. CPC G07C 5/008; G06Q 50/30; H04W 4/40; G07C 5/085; H04W 4/90; G01C 21/3438

(57) ABSTRACT

This invention is a rideshare safety system that utilizes ridesharing passenger and driver mobile devices to record, store, and transmit emergency information, including location data, video from the front and rear cameras, and communications from the rideshare passenger and driver mobile devices to third-party user mobile devices, and stores the emergency information on a central server. The third-party user interface displays the video for monitoring by the third-party user. This invention facilitates the transmission of emergency information from the passenger and driver to third-party users and emergency responders.

### CROSS-REFERENCE TO RELATED APPLICATION

This application claims the priority of U.S. Provisional Patent Application No. 62/607,925 filed on Dec. 20, 2017.

### BACKGROUND OF THE INVENTION

Safety is a primary concern for both drivers and passengers of rideshare services. Currently, there are no applications known in the art that facilitate the use of the front and rear cameras of the rideshare passenger mobile device and the rideshare driver mobile device to record video data of the ride, store a recording of the video data on an external server, provide a live feed to the video data with location data from the passenger's mobile device, with other necessary emergency information, to third-parties who monitor the ride on their mobile device and assist during emergencies by alerting emergency responders.

### SUMMARY OF THE INVENTION

This invention is related to the field of rideshare data recording, storage and transmittal systems and programs stored on one or more computer readable mediums, including one or more mobile devices, and one or more external servers.

The users of this invention are ridesharing passengers, drivers, and any third-party, and emergency responders with whom this invention stores and transmits rideshare data.

Third-party users may include any person with a mobile device or any other device from any location with internet services. A third-party user may be a virtual call center user that uses this invention to observe and monitor a rideshare video and may be any emergency responder such as law enforcement, medical providers, the fire department, and any person designated by the passenger as an emergency contact.

Rideshares services include taxi and other transportation services involving at least one passenger and at least one driver, and transporters of cargo.

The technical problem faced by rideshare passengers and rideshare drivers is there is no known safety system that utilizes the front and rear cameras of the driver and passenger phones to record and transmit rideshare video and location data, along with emergency information, to a third-party user who monitors the ride for safety and responds to emergency requests.

### DETAILED DESCRIPTION OF INVENTION

This invention is an application run by a series of programs contained on one or more computer readable mediums that may be used in conjunction with, or in addition to, a rideshare service application.

In a preferred embodiment, the rideshare services are Uber, Lyft, Sidecar, and this invention, referred to as the Beeline Rides™ application, and may be any application used by passengers and drivers to provide rideshare services.

In a preferred embodiment, this invention records video data through the front and rear cameras of a first mobile device. In a preferred embodiment, the first mobile device is a mobile device of a ridesharing passenger. In another embodiment, only the front camera of the first mobile device is used; and in another embodiment, only the rear camera of the first mobile device is used.

In a preferred embodiment, this invention records video data through the front and rear camera of a second mobile device. In a preferred embodiment, the second mobile device is the mobile device of a driver of a ridesharing service.

In another embodiment, only the front camera of the second mobile device is used; and in another embodiment, only the rear camera of the second mobile device is used.

In a preferred embodiment, this invention records video data through the front and rear cameras of the first and second mobile devices. In another embodiment, any combination of front and rear cameras of the first and second mobile devices are used to record video data.

In a preferred embodiment, the rideshare video data is transmitted to one or more third-party user devices.

In one embodiment, the video recording data is uploaded to one or more servers to be stored on a computer readable medium.

In one embodiment, the video data is deleted in three months. In another embodiment, the video and data are deleted after a predetermined period of time. In another embodiment, the first mobile device user interface queries the first mobile device user to delete the video; and when an instruction to delete the video and rideshare data is received by the rideshare safety system application, this invention deletes the rideshare video and data.

In a preferred embodiment, this invention is characterized by a first mobile device user interface that queries the first mobile device user to input emergency information into the first mobile device that is stored on the first mobile device.

In a preferred embodiment, the first mobile device user interface queries the first mobile device user to transmit rideshare data to a server; and when an instruction to transmit rideshare data to a server is received, this invention transmits the rideshare data to the server where the rideshare data is stored in a database on a computer readable medium.

In a preferred embodiment, the first mobile device user interface queries the first mobile device user to transmit the rideshare data to one or more third-party users, and when an instruction to transmit rideshare data to a third-party user device is received, this invention transmits the rideshare data to a third-party user device.

In a preferred embodiment, the rideshare data is characterized by emergency information that includes the name, contact information, and relationship to the first mobile device user of one or more emergency contacts, in addition to any medical conditions of the first mobile device user.

In a preferred embodiment, the emergency information is event based such as the name of the rideshare service application of the first mobile device user, the date and time of the ride, and the name and contact information of the second mobile device user.

In one embodiment, the emergency information includes comments from a third-party device user describing the nature of the emergency and the identity and contact information of the first and second mobile device users.

In one embodiment, the first mobile device user emergency information is transmitted to a database on a computer readable medium to be stored for a predetermined amount of time. In another embodiment, the first mobile device user emergency contact information is stored on the first mobile device.

In a preferred embodiment, the first mobile device user emergency information is stored on the second mobile device and transmitted to a database to be stored for a predetermined period.

In a preferred embodiment, this invention is characterized by a first mobile device user interface that queries the first mobile device user to transmit the rideshare data to a third-party mobile device; that when instructed, transmits data to a third-party mobile device. Rideshare data is further characterized by video, audio, and location data.

In one embodiment, the first mobile device user interface queries the first mobile device user to create a list of emergency contacts by providing a series of fields that queries the first mobile device user to input emergency contact information; that when inputted into the field, is stored on a computer readable medium for data retrieval and transmission.

In a preferred embodiment, the first mobile device user interface queries the first mobile device user to select an emergency contact from the contact list on the first mobile device, which may be any one or any combination of the following: a relative, sibling, spouse, caregiver, friend, and any other person the first mobile device manually enters into the device, or selects from the first mobile device contact list.

In a preferred embodiment, the first mobile device user interface queries the first mobile device user to select third-party users with whom to share the video recording from a list of contacts imported from the contact list of the first mobile device.

In a preferred embodiment, this invention is characterized by a first mobile device user interface that queries the first mobile device to transmit rideshare data to a third-party who monitors the ride for safety; that when instructed, transmits rideshare data to a third-party user. The third-party user is characterized as a friend, family member, virtual call center user, an emergency responder such as law enforcement, medical provider, fire department personnel, or any person selected by the first mobile device user from the first mobile device contact list.

In a preferred embodiment, the first mobile device user interface will query the first mobile device to stop the video recording of the ride; that when the first mobile device user interface receives an instruction from the first mobile device user to stop recording a video of the ride, this invention stops the video recording of the ride.

In one embodiment, the first mobile device user interface queries the first mobile device to share the video recording with one or more third-party users; that when the first mobile device user interface receives an instruction from the first mobile device user to share the video with one or more third-party users, this invention transmits a live video stream with rideshare data to one or more third-party user device, where the video and rideshare data is displayed on a third-party user interface of a third-party device.

In one embodiment, the first mobile device user interface queries the first mobile device user to select a link; that when selected, queries the first mobile device user to choose a phone number from the contact list of the first mobile device; to whom the first mobile device transmits the video and rideshare data in real-time.

In one embodiment, if the first mobile device user chooses to share video or rideshare data with a third-party, this invention will charge the user of the first mobile device an additional fee.

In one embodiment, the first mobile device user interface queries the first mobile device user to select a notification to be sent by text or email to the mobile device of an emergency contact; that when the first mobile device user interface receives an instruction from the first mobile device user to send a notification by text or email to the mobile device of the emergency contact, this invention sends a text or email to the device of the emergency contact.

In one embodiment, the first mobile device user interface queries the first mobile device to send rideshare data to an emergency contact; that when the first mobile device user interface receives an instruction from the first mobile device user to send rideshare data to an emergency contact, this invention sends rideshare data to the emergency contact.

In one embodiment, the third-party user interface queries the third-party user to input an update into a field of the third-party user interface as to the status of the first mobile device user and any pending or ongoing emergency responses; that when the third-party user interface receives an instruction and a status update has been inputted by the third-party user into the third-party user interface as to the status of the first mobile device user or any pending or ongoing emergency response, this invention transmits the status update to the first mobile device user interface and any third-party user interfaces.

In one embodiment, the first mobile device user interface queries the first mobile device user to disable comments and status updates from the second mobile device user to any third-party user; that when the first mobile device user interface receives an instruction from the first mobile device user to disable comments and status updates from the second mobile device user, or an aggressor to any third-party user, this invention disables comments and status updates from the second mobile device user interface or the device of the aggressor. The aggressor is characterized by any person causing harm to the first mobile device user or second mobile device user. Disabling comments and status updates prevents the second mobile device user or aggressor from providing misleading or false information to any third-party or emergency responder.

In one embodiment, the third-party user interface queries the third-party user as to whether the first mobile device user is unconscious or whether the first mobile device user does not have the ability to respond and give updates; that when the third-party user interface receives an instruction from the third-party user that the first mobile device user is unconscious or does not have the ability to respond and give updates, this invention will disable the ability of the second mobile device or aggressor to provide comments, status updates, or any misleading information through the second mobile device user interface.

In one embodiment, the third-party user interface of an emergency responder queries the emergency responder user to provide comments and updates to the first mobile device user emergency contact, that when the emergency responder user interface receives an instruction from the first mobile device user to provide comments and updates, this invention sends any comments inputted into the third-party user interface to the emergency contact of the first mobile device user and the first mobile device user.

In one embodiment, the third-party user interface will query the third-party user to transmit rideshare data and emergency information to emergency responders, that when the emergency responder user interface receives an instruction from the third-party user to transmit rideshare data and emergency information to emergency responders, this invention transmits the rideshare data and the emergency information to the emergency responder. Emergency information is further characterized by the location of the first mobile device user, one or more victim, one or more aggressor, and any medical or emergency services and any medical or emergency tools to aid in the emergency response.

In one embodiment, this invention transmits the rideshare data and emergency information using text message, email, robocalls, a web URL link, or any combination of methods of transmitting information that are known in the art.

The emergency information may be any combination, and any one of the following: location data characterized by GPS coordinates, video of the incident in real-time, video that is recorded from the start of the ride and stored on one or more mobile devices, or one or more servers, a photo of the first mobile device and second mobile device for identification purposes, a list identifying any victims and aggressors, comments provided by the third-party users or any person who contacted the authorities such as the first mobile device user or the second mobile device.

In one embodiment, the identity of an of the device users is confirmed through a fingerprint scanner on the phone.

In one embodiment, the first mobile device user interface queries the first mobile device user to select an emergency responder to contact from a list of emergency responders, that when an instruction to contact an emergency responder is received, this invention contacts the emergency responder.

In one embodiment, the second mobile device user interface queries the second mobile device user to select an emergency responder to contact from a list of emergency responders; that when an instruction to contact an emergency responder is received, this invention contacts the specified emergency responder.

In one embodiment, the third-party user interface queries the third-party user to select an emergency responder to contact from a list of emergency responders, that when an instruction to contact an emergency responder is received, this invention contacts the specified emergency responder.

In one embodiment, the first mobile device user interface, the second mobile device user interface, and the third-party user interface have default settings to contact all authorities for assistance when an instruction to contact an emergency responder is received and a predetermined amount of time has passed without selecting an emergency responder.

In one embodiment, this invention is characterized by a direct line to a police dispatcher that transmits emergency information by text, email, video, chat, and Website URL, and phone calls.

In one embodiment, this invention is characterized by sensors that monitor whether the third-party user is actively watching the ride by requiring the third-party user to interact with the application, the second mobile device user, or the first mobile device user by any one or combination of the following: facial identification or recognition software; detection software that detects whether the third-party is looking at the screen of the mobile device or computer, or whether the third-party user is sleeping, not present, distracted, playing games, or distracted with other applications on the device or computer such as surfing the internet, playing games, or using other applications.

In one embodiment, the third-party user interface is characterized by facial recognition software that identifies whether the person looking at the screen is the third-party user that is registered to monitor the ride. In one embodiment, the third-party user has the option to transfer the responsibility to monitor the ride to another registered third-party user.

In one embodiment, the third-party user interface queries the third-party user to place the third-party user's finger on a fingerprint scanner and will compare the third-party user's fingerprint to the fingerprint of the registered third-party user; that when a match is found, enables the invention, and when a match is not found, disables the invention.

In one embodiment, the third-party user interface queries the third-party user to touch a scanner to make sure that the third-party user is actively monitoring the ride; that when the third-party user does not touch the fingerprint scanner, the third-party user interface will instruct the third-party user mobile device or computer to emit an audio, voice, or vibration alert from the third-party user device.

In one embodiment, the third-party user interface queries the third-party user to touch the screen or interact with the application by doing any one or any combination of the following to ensure the third-party is paying attention: drawing patterns on the screen, use of multi-touch such as two or three fingers, typing or entering a random code shown on an image on the screen of the third-party user interface, or any combination of these interactions.

In one embodiment, the third-party user interface is characterized by a chat box that sends and receives message from the first mobile device user interface to one or more third-party user interfaces.

In one embodiment, the third-party user interface queries the third-party user to select one or more videos from any one or more of the following: the front camera of the first mobile device, the rear camera of the first mobile device, the front camera of the second mobile device, the rear camera of the second mobile device, or any combination of the front and rear cameras of the first mobile device and the second mobile device.

In one embodiment, the third-party user interface queries the third-party user to send an alert to the first mobile device; that when instructed to send an alert to the first mobile device, this invention sends an alert to the first mobile device.

In one embodiment, the third-party user interface queries the third-party user to send an alert to the second mobile device; that when instructed, sends an alert to the second mobile device, this invention sends an alert to the second mobile device. The alerts are characterized as text messages, or messages pushed through the application, or through a voice alert like a walkie-talkie or a robocall voice message reading a typed message.

In one embodiment, the alert activates if a camera on the second mobile device is covered.

In one embodiment, the mobile devices of this invention record in environments with low lighting by using software and hardware that detects colors and lighting, or by any other software and hardware known in the art to record video in low light conditions.

In a preferred embodiment, the user interface is further characterized by an emergency screen that includes a panic button that is activated through the touch of the screen or through an audio command. The emergency button may be activated by a tactile pattern, a predetermined voice command, a push of predetermined button on the mobile device, or by swiping on the edge of the screen of the mobile device.

The tactile pattern is further characterized by any one, or combination, of the following: a multi touch such as using two or three fingers, drawing circles, writing “911” on the screen, tapping the screen in a predetermined pattern, or swiping the screen with the palm or fingers from edge to edge, or by pressing a button on the screen.

In one embodiment, the invention queries the virtual call center user to interact with the user interface within a predetermined time interval, and when the virtual call center user does not interact with the user interface within a predetermined time interval, the virtual call center user user interface redirects the call to another virtual call center user. The interaction with the user interface may be by touching the screen, talking to the device, talking with the first mobile device, or by touching the device every thirty seconds.

In one embodiment, facial recognition technology is implemented to ensure that the virtual call center user is watching the live feed of the surveillance video; whereby, the facial recognition technology from the mobile device detects if the virtual call center user is not looking at the phone or if the virtual call center user is falling asleep. If the facial recognition technology detects that the virtual call center user has fallen asleep or is no longer paying attention, the virtual call center user user interface will cause an alert to sound from the virtual call center user device.

In one embodiment, the emergency screen of the user interface will query the user to input emergency information data into a series of data fields; that when instructed to transmit the emergency information, transmits the emergency data to emergency responders.

In one embodiment, the emergency screen is characterized by a button; that when activated, transmits emergency information by email, text message, or a robocall, immediately. In one embodiment, the emergency information is characterized by location data, GPS coordinates, emergency contact information, rideshare trip information such as the origin and destination of the trip, in addition to the identity of the second mobile device, a copy of the driver's license, and the year, make, model, license plate number, and the vehicle identification number (VIN) of the second mobile device user's vehicle.

In one embodiment, any one or any combination of the users of this invention can invoke the emergency screen.

In one embodiment, the user interfaces of this invention queries the users of this invention to provide additional information to help emergency responders identify the nature of the emergency and any required medical tools, products or treatments necessary to respond to the emergency. The emergency responders may be any one, or any combination of law enforcement, fire department, and medical personnel.

In one embodiment, the user interfaces of this invention queries the user to fill out a list, choose from a list, and place a checkmark to identify the type of emergency from a list that includes any one, or any combination of the following: violence, sexual assault, shooting, stabbing, car accident, heart attack, or any other medical or emergency situation; that when a type of emergency is selected, contacts a predetermined emergency responder.

In one embodiment, the user interface of this invention queries the user to provide additional comments into a text field, that when text is inputted into the text field, transmits the comment to other users and emergency responders.

In one embodiment, the user interface queries the user to select the method to transmit emergency information to the emergency responder, including any one, or combination of the following: phone call, robocall, typed messages, text messages, chat, and email.

In one embodiment, this invention automatically sends the contact information of the third-party user to the emergency responders to obtain more information about the incident and identify any witnesses.

In one embodiment, the application has an option for users to contact the emergency responder in the case of an emergency.

In a preferred embodiment, the video data of the ride is transmitted to a third-party device of an emergency responder where the emergency responder can view the video data through the third-party interface.

In a preferred embodiment, this invention records the location data, route map, and GPS coordinates, and transmits the rideshare data to the emergency responders through a voice or text message or any other manner of communication.

In one embodiment, when the first mobile device user sends a request to view the video recording, or live video feed, to a third-party user, the application will send a text message with a link, and when the link is clicked, the link provides the third-party user with a prerecorded video, or a live video stream. In a preferred embodiment, these recordings are stored on a server. In one embodiment, the videos are recorded any combination of the passenger, driver, and third-party user device.

In one embodiment, this invention is characterized by a third-party user who monitors the ride through a third-party user device as part of a mobile virtual call center. The virtual call center will save on the cost of a centralized call centers located in offices spaces or buildings, which allows third-party virtual call center users of this invention to earn an income at any time and place with internet service.

In one embodiment, the virtual call center will have a virtual call center user who will be able to provide customer service, interact with customers, and provide security monitoring services through their virtual call center user devices.

The virtual call center user device may be a cell phone, tablet, watch, such as the Apple Watch, or any other computer or mobile device known in the art capable of mobile transport.

In one embodiment, the third-party user interface will verify that the virtual call center user has passed a background check to be a virtual call center user. In one embodiment, the virtual call center user is a stay at home mom, a security guard, or another person who has met the predetermined virtual call center user requirements.

In one embodiment, the third-party user interface is characterized by a payment feature that transfers payments to the virtual call center user for watching surveillance videos of rides and accurately reporting problems to emergency responders and other third-parties. In one embodiment, compensation is based per call, and in another, by call duration.

In a preferred embodiment, the first mobile device user interface will query the first mobile device user to send a request to a virtual call center user, that when instructed to do so, this invention will transmit the request to the virtual call center user through the virtual call center user interface. Upon receiving the request, the virtual call center user interface queries the virtual call center user to accept the call, and if accepted, the first mobile device user interface will transmit the video of the ride to the virtual call center user interface and the virtual call center user interface will display the video of the ride for the virtual call center user to monitor.

In one embodiment, this invention also transmits video from the second mobile device, in addition to any video transmitted from the first mobile device, that will be displayed on the virtual call center user interface of the virtual call center user's third-party user device.

In one embodiment, if the virtual call center user observes an emergency incident, and the virtual call center user indicates there is an emergency by selecting the emergency button on the third-party user interface, this invention will contact a device of an emergency responder, emergency contact, or any combination of an emergency responder and an emergency contact, through the Beeline Ride™ application.

In one embodiment, if the virtual call center user selects the emergency button on the virtual call center user device, the video of the emergency incident will be recorded and saved on the first mobile device, and transmitted to the device of an emergency responder, emergency contact, a server, or to any combination of an emergency responder, emergency contact, and server, for storage.

In one embodiment, if the virtual call center user selects the emergency button, the location data of the first mobile device is transmitted to a server, an emergency responder, an emergency contact, or to any combination of an emergency responder, emergency contact, and server, for storage.

In one embodiment, if the virtual call center third-party device detects the virtual center user fails to monitor the rides they are assigned to monitor, the user interface will restrict the virtual call center user from receiving additional calls to monitor rides. In one embodiment, a company policy requires the virtual call center user to stay awake and alert while monitoring rides.

In one embodiment, there is more than one virtual call center user.

In one embodiment, the virtual call center user interface will query the virtual call center user to make an emergency call from the virtual call center user mobile device, or devices, or press a button to notify emergency authorities, such as the police, emergency medical technicians, and the fire department.

In one embodiment, the virtual call center user interface will query the virtual call center user to select a button to send emergency data characterized by location data, GPS coordinates, voice recordings, video recordings, live video stream, live audio stream, and other second mobile device and first mobile device emergency information to the device of one or more emergency responders.

In one embodiment, nearby users of the invention will receive notifications on their mobile devices through a mobile application, so that they may assist by contacting the authorities or flagging down law enforcement near the incident, like an amber alert.

This invention also has an option in the administrative dashboard of the administrative user interface to adjust the monthly pricing. In one embodiment, the monthly pricing is set at five dollars per month but may be any amount selected by the user. In one embodiment, the first mobile device is not charged, and in another embodiment, the first mobile device is charged. In one embodiment, users from different groups have different price points. In one embodiment, users who are designated renters, will be part of a “renters” user group, and will not be charged, while users who are not renting cars will be included in the “non-renters” group, and will pay $10 per month, or any other amount. In one embodiment, this invention shall tier the payment depending on who the first mobile device chooses to watch the ride. In one embodiment, having a virtual call center user monitor the ride will add to the cost of the service.

Paying customer could submit complaints on the application if they feel the virtual call center user is not monitoring the first mobile device user's ride. If the virtual call center user receives complaints more than a predetermined amount, the virtual call center user will be terminated from the job and banned from using the application.

In one embodiment, this invention allows second mobile devices to run a rideshare application while this invention is running and visible in the second mobile device user interface. In another embodiment, the invention is an application that runs in the background.

In one embodiment, the third-party user device receives multiple requests to monitor the ride.

In one embodiment, the user interface will increase the display size of the third-party user interface to allow the third-party user to simultaneously monitor multiple requests. The advantage of this invention is the virtual call center users will be able to earn more money in a shorter period. In one embodiment, the virtual call center user earns ten dollars per hour, per request, to monitor rides. In one embodiment, if the virtual call center user receives three simultaneous requests, then the virtual call center user will earn thirty dollars per hour.

In one embodiment, the virtual call center monitors any security watch situation, and not just rideshare applications. In one embodiment, the virtual call center user monitors security cameras at warehouses. In one embodiment, the virtual call center user monitors a babysitter. In one embodiment, the virtual call center user monitors first device users in predetermined locations where crime is prevalent.

### BRIEF DESCRIPTION OF THE DRAWINGS

FIG. 1 illustrates the recording, storage and transmission of video, audio, location, emergency, and other rideshare data through the rideshare safety system.

FIG. 2 illustrates the transmission of the video recordings from the front and rear cameras of the second mobile device and the first mobile device to a third user device.

FIG. 3 is a diagram that illustrates the transmission of the rideshare video in the rideshare safety system.

FIG. 4 illustrates a preferred embodiment of the third-party user interface video monitoring screen characterized by live video feed and messaging from the first mobile device and second mobile device.

FIG. 5 illustrates a preferred embodiment of the third-party user interface video monitoring screen characterized by live video feed and messaging from the first mobile device and second mobile device and a toggle feature.

FIG. 6 illustrates a preferred embodiment of the third-party user interface emergency screen.

### DETAILED DESCRIPTION OF THE DRAWINGS

Further objects and advantages of the invention can be more fully understood from the following detailed description taken in conjunction with the accompanying drawings in which:

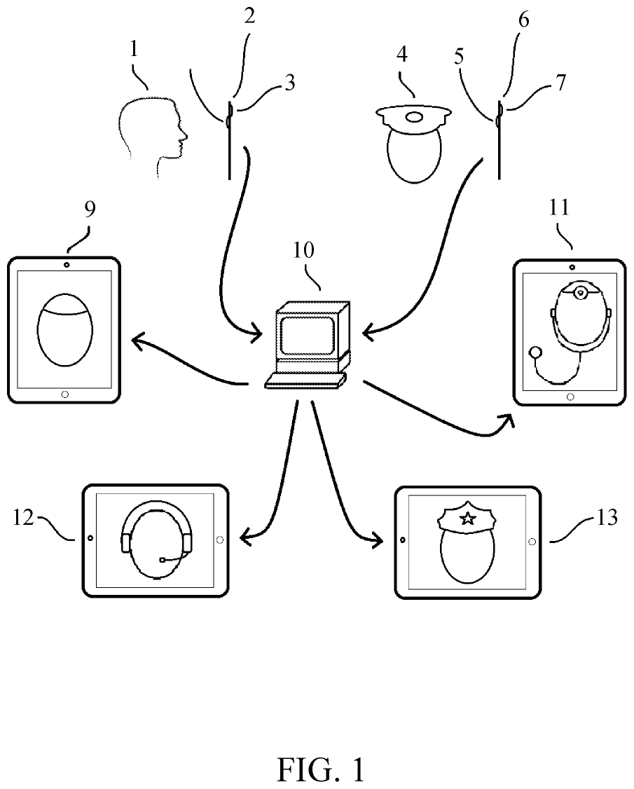

FIG. 1 illustrates the recording, storage and transmission of video, audio and rideshare data through the rideshare safety system. The first mobile device user 1 initiates a rideshare application with this invention, the rideshare safety system. The first mobile device front camera 2 records video and audio that is stored as a computer readable medium on the first mobile device 3 and transmitted and stored on a central database server 10. The first mobile device rear camera 4 records video and audio that is stored as a computer readable medium on the first mobile device 3 and transmitted and stored on a central database server 10. The second mobile device 5 initiates a rideshare application with this safety system application. The second mobile device front camera 6 records video and audio that is stored as a computer readable medium on the second mobile device 7 and transmitted and stored on a database on the central server 10. The second mobile device rear camera 8 records video and audio that is stored as a computer readable medium on the second mobile device 7 and transmitted and stored in a database on the central server 10. The database on the central server 10 transmits the video and audio data as computer readable medium to the third-party device 9. The database on the central server 10 transmits the video and audio data as computer readable medium to the medical responder device 11. The video is transmitted from the central server 10 as computer readable medium to the virtual call center user device 12. The central server 10 transmits the video and audio data as computer readable medium to devices of emergency responder device 13.

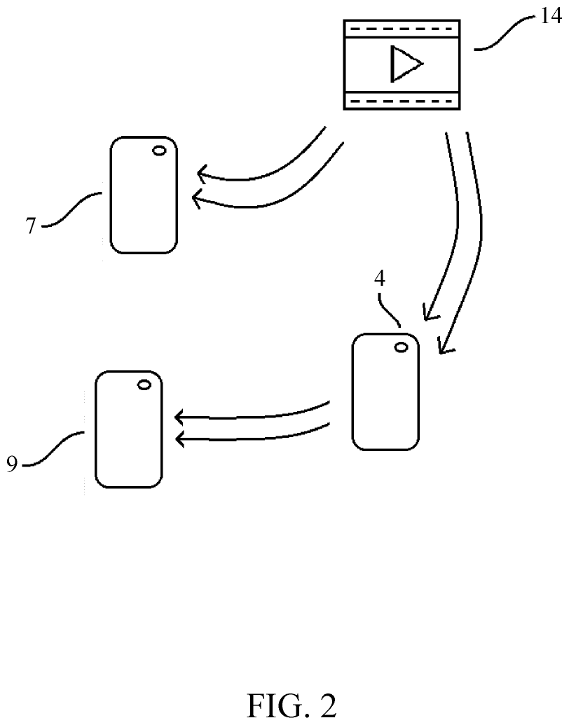

FIG. 2 illustrates the transmission of the video recordings from the front and rear cameras 14 as computer readable medium 14 from the second mobile device 7 and the first mobile device 3 to a third-party device 9.

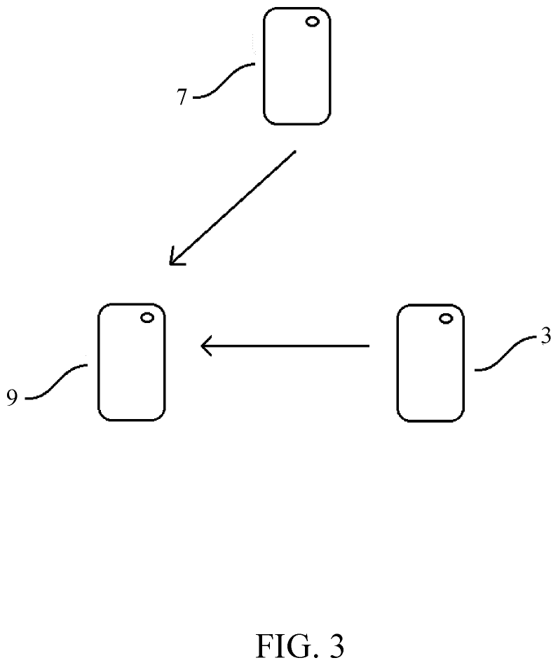

FIG. 3 is a diagram that illustrates the streaming of the rideshare video from the second mobile device 7 in the Rideshare Safety System. If the second mobile device user covers the front or rear camera on the second mobile device 7 an alert will be transmitted to a third-party user device with a live video feed. This will deter the second mobile device user from engaging in criminal acts. When the device detects limited bandwidth, this application will alert the first mobile device user to choose which third-party user device to stream the video to the third-party user device 9. The first mobile device user shall have the option to press an emergency button to contact emergency responders. The third-party user device 9 will display a live video feed from the front and rear cameras and will transmit a notification to a virtual call center user on the third-party user device 9. If selected, the video feed will be transmitted to a virtual call center user on a third-party user device. Based on a predetermined condition, the call will be sent to a virtual call center user device. The first mobile device user will have the option to select another virtual call center user device to transmit the video, if the bandwidth is below a predetermined value. The first mobile device user will be queried to provide a reason to select a different virtual call center user. If a predetermined reason is selected, the first mobile device user will be charged an additional fee.

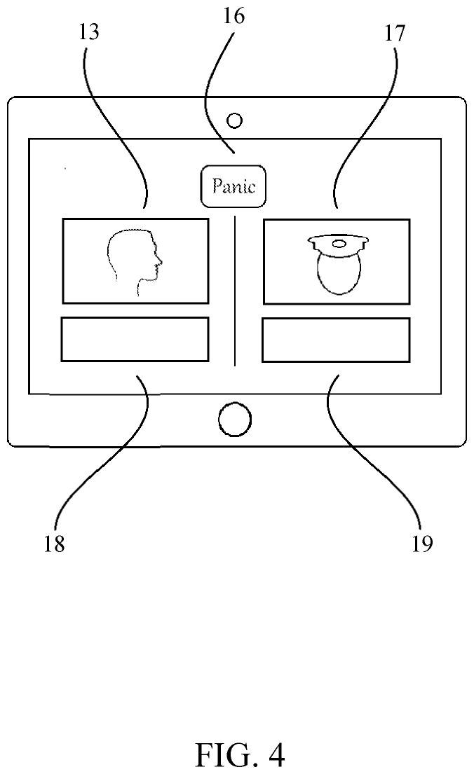

FIG. 4 illustrates a preferred embodiment of the third-party device user interface characterized by a second mobile device video screen 15 that displays videos transmitted from the second mobile device, a panic button 16 that the third-party user may select to notify and transmit video data to a medical responder or Law enforcement responder user device, a first mobile device video screen 17 that displays videos transmitted from the first mobile device, and a first mobile device user text box 19 that displays messages from the first mobile device user.

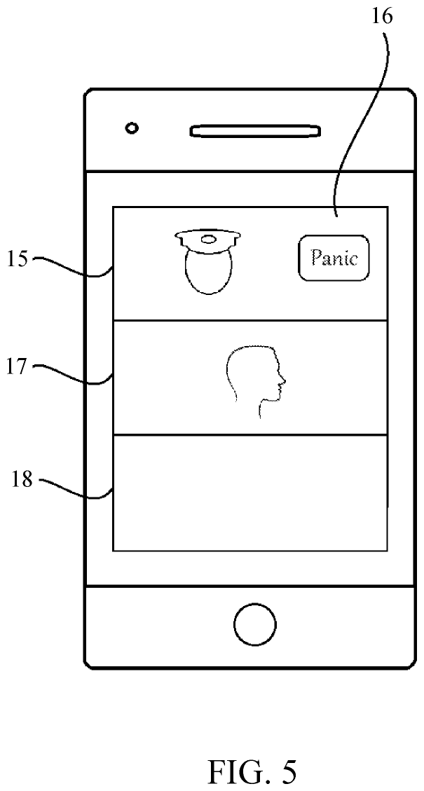

FIG. 5 illustrates a preferred embodiment of the third-party user interface display showing a third-party user chat box 20 which allows the third-party to send and receive messages. The preferred embodiment illustrated in FIG. 5 allows the third-party user to alternate between the second mobile device live video feed 15 and the first mobile device live video feed 17 while zooming-in and zooming-out.

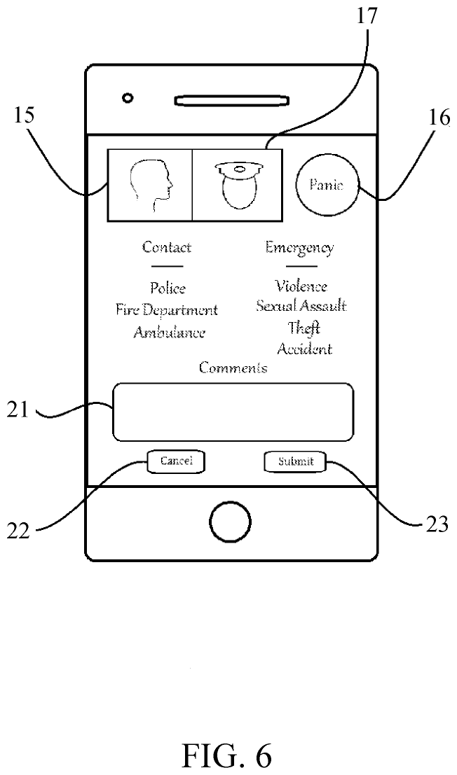

FIG. 6 illustrates a preferred embodiment of the third-party user interface emergency screen characterized by a first mobile device live video feed 15, a second mobile device live video feed 17, an emergency panic button 16, a list of emergency responders to stream a live video feed, and a comment box 21 for entering and sending messages. This preferred embodiment has a cancel button 22 for canceling the request, and a third-party user interface emergency screen and a submit button 23, that when selected, transmits a notification to an emergency responder.

1. A data recording and transmittal system comprising of a first mobile device characterized by a video camera, an audio recording component, a user interface, a GPS receiver, a data transmittal component, and a software application; and a second mobile device characterized by a video camera, an audio recording component, a user interface, a GPS receiver, a data transmittal component, and a software application; and an external server characterized by a data transmission component and a data storage component; and a third device characterized by a user interface, a data transmission device, and a mobile application; whereby the first mobile device records and transmits video to the external server; and the second mobile device records and transmits video to the external server; and the external server stores and transmits the videos from the first mobile device and the second mobile device to the third device; whereby the first mobile device is further characterized by a forward facing video camera, a rear facing video camera, and an audio recording component; and a second mobile device further characterized by a forward facing video camera, a rear facing video camera, and an audio recording component.

2. The data recording and transmittal system of claim 1, further comprised of a user interface of a first mobile device characterized by a feature that when engaged by the user instructs the data transmittal component of a first mobile device to transmit video data from the first mobile device to the external server that then stores and transmits the video data of the first mobile device to a third mobile device.

3. The data recording and transmittal system of claim 2, further comprised of a user interface of a second mobile device characterized by a feature that when engaged by a user instructs the data transmittal component of a second mobile device to transmit video data from a second mobile device to the external server that then stores and transmits the video data of a second mobile device to a third mobile device.

4. The data recording and transmittal system of claim 3, further comprised of a user interface of a first mobile device further characterized by a user interface that queries the user to input emergency contact information, a data transmittal device that transmits the emergency contact information to an external server, an external server where the emergency contact information is stored in a database on a computer readable medium, and a feature of a first mobile device that when engaged by the user instructs the data transmittal device of a first mobile device to transmit the emergency contact information to a third mobile device.

5. The data recording and transmittal system of claim 4, further comprised of a user interface of a first mobile device characterized by an emergency screen characterized by a query of emergency contacts, a query of the nature of the emergency, a query to enter comments, and a query to transmit the data that when engaged, transmits emergency information to an external server.

6. The data recording and transmittal system of claim 5, further comprised of a user interface of a first mobile device characterized by an emergency screen characterized by event-based emergency information that is characterized by the rideshare applications in use by the user, the date and time of the ride, and the name and contact information of the driver-user; and a query to transmit the event-based emergency information to an external server, that when engaged, transmits the event-based emergency information to an external server.

7. The data recording and transmittal system of claim 6, further comprised of a third mobile device that is further characterized by a user interface that displays the video data from a first mobile device.

8. The data recording and transmittal system of claim 7, further comprised of a third mobile device that is further characterized by a user interface that displays the video data from a second mobile device.

9. The data recording and transmittal system of claim 8, further comprised of a third mobile device that is further characterized by a user interface that displays text communications transmitted from a first mobile device and receives communication inputs from the user of a third mobile device and transmits the communication inputs from a third mobile device to a first mobile device.

10. The data recording and transmittal system of claim 9, further comprised of a third mobile device that is further characterized by a user interface component that uses facial recognition software to detect whether the user of the third-party device is interacting with a third mobile device.

11. The data recording and transmittal system of claim 10, further comprised of an emergency responder device that is characterized by a user interface, a data transmission device, and a software application, whereby the user interface displays video data from a first mobile device.

12. The data recording and transmittal system of claim 11, further comprised of an emergency responder device that is characterized by a user interface, a data transmission device, and a software application, whereby the user interface displays video data from a second mobile device.

13. The data recording and transmittal system of claim 12, further comprised of an emergency responder device that is characterized by a user interface, a data transmission device, and a software application, whereby the user interface displays video data from a third mobile device.

14. The data recording and transmittal system of claim 13, further comprised of an emergency responder device that is further characterized by a user interface that displays text communications transmitted from a first mobile device, and receives communication inputs from the user of a emergency responder device that transmits the communication inputs to a first mobile device.

15. The data recording and transmittal system of claim 14, further comprised of an emergency responder device that is further characterized by a user interface that displays text communications transmitted from a second mobile device, and receives communication inputs from the user of a emergency responder device that transmits the communication inputs to a second mobile device.

16. The data recording and transmittal system of claim 15, further comprised of an emergency responder device that is further characterized by a user interface that displays text communications transmitted from a third mobile device and receives communication inputs from the user of an emergency responder device that transmits the communication inputs to a third mobile device.
